(19) United States
(12) Patent Application Publication
(10) Pub. No.: US 2020/0020246 A1
(43) Pub. Date: Jan. 16, 2020

(54) MemoZing e-learning system

(71) Applicant: Thomas Dobler, Funchal (PT)

(72) Inventor: Thomas Dobler, Funchal (PT)

(21) Appl. No.: 16/035,591

(22) Filed: Jul. 14, 2018

(51) Int. Cl. G09B 19/00

(52) U.S. Cl. CPC G09B 19/00

(57) ABSTRACT

The utility model discloses memorizing and the development of the learning platform with 10 words which are the optimal number to learn. The conscious perception is much less than subconscious perception. For this the system works with both factors. The deepening of knowledge in this way brings great advantages in terms of learning speed and memory.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to the field of e-learning platform for new words generated to make learning particularly effective and quick using subconscious and conscious mind.

### DESCRIPTION OF THE RELATED ART

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Various computer-based vocabulary programs exist and are well known in the art. These programs work in conjunction with various computer-based devices and programs such as word processors, e-mail programs, web page generation programs and the like, to provide vocabulary assistance, such as definitions, meanings of prefixes, roots and suffixes, and word origins. Each of these existing products looks at one particular word at a time and focus on one type of assistance. The programs do not make comparisons among similar words or enable a person to make connections among the meanings of various suffixes, roots and prefixes.

An additional problem with the prior art computer based learning tools is that the programs are hardware dependent and must be downloaded and installed, creating issues such as operating system requirements, hard-drive capacity, minimum ram requirements, availability of IT support, high implementation costs for users such as school and school districts, etc.

However, to Applicant's knowledge, none of these prior art methods have been found to be completely suitable to meet these needs and are cumbersome. There has not, to date, been a product that is designed to accomplish all of these goals and to provide a student with a comprehensive vocabulary learning tool. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

This invention is an e-learning platform. There are always 10 words connected to each other and these words are always learned together. This creates a knowledge network. If you are reminded of one of these 10 words, the other words in this thread will be addressed at the same time. It is irrelevant whether the vocabulary matches thematically. These words are then entered in pairs in our input mask. The input is by question and answer, whereby the question and also the answer may not contain more than 75 characters. We have limited the number of characters because our system also works the subconscious. After the vocabulary has been entered, it can be learned.

During learning, the vocabulary to be learned at that moment is displayed in a blue color. Whereby colour is not the invention but only the highlighting of the learning content. At the same time, a vocabulary in front of it and a vocabulary afterwards (i.e. from this set of ten) is briefly faded in light gray color. Then again the blue colored vocabulary. The learner should concentrate exclusively on the coloured vocabulary and try to consciously ignore the light grey vocabulary. This creates an imprint in the subconscious mind. This makes learning particularly effective and quick.

As a further improvement of the present invention, Once the 10 words have been learned, a short multiple choice test is performed.

As a further improvement of the present invention, Since vocabulary is forgotten after some time, the system analyzes the learner. At exactly the statistically correct moment, our system approaches the learner and queries this vocabulary again. In this way we ensure that what we have learned is transferred into long-term memory. The pauses between the learning units increase if what has been learned could be repeated correctly more often.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic view of the invention in which light grey vocabulary need to be ignored which creates an imprint in the subconscious mind.

FIG. 2 shows blue vocabulary where user needs to concentrate exclusively.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

The proposed system is an e-learning platform. There are always 10 words connected to each other and these words are always learned together. This creates a knowledge network. If user is reminded of one of these 10 words, the other words in this thread will be addressed at the same time. It is irrelevant whether the vocabulary matches thematically. These words are then entered in pairs in our input mask. The input is by question and answer, whereby the question and also the answer may not contain more than 75 characters. We use limited the number of characters because our system also works with the subconscious. After the vocabulary has been entered, it can be learned. During learning, the vocabulary to be learned at that moment is displayed in a blue color. At the same time, a vocabulary in front of it and a vocabulary afterwards (i.e. from this set of ten) is briefly faded in light gray color. Then again the blue colored vocabulary. The learner should concentrate exclusively on the coloured vocabulary and try to consciously ignore the light grey vocabulary. This creates an imprint in the subconscious mind. This makes learning particularly effective and quick.

Once the 10 words have been learned, a short multiple choice test is performed. At the same time, system analyses how well each individual vocabulary has been learned. We analyze the entire learning process. This consists of learning from life, which means we measure the time how long which vocabulary is looked at and also determine how many letters are contained in this vocabulary. In order to further consolidate the knowledge, a vocabulary sheet can be printed out from the system, which consists of 3 gaps. The first column contains the questions, the second column is empty and the third column contains the answers. If the pupil, student or learner prints out the sheet of paper, he can fold the solution backwards and also consolidate what he has learned by writing. The more input channels are used for learning. For this reason, our system also offers the possibility of voice output in different national languages.

Since vocabulary is forgotten after some time, our system analyzes the learner. At exactly the statistically correct moment, our system approaches the learner and queries this vocabulary, again. In this way we ensure that what we have learned is transferred into long-term memory. The pauses between the learning units increase if what has been learned could be repeated correctly more often. For example, standard repetitions are as follows: 1. repetition after 2 hours, the 2nd repetition after one day, the 3rd repetition after 2 days, the 4th repetition after one week, the 5th repetition after 2 weeks, the 6th repetition after one month, then after 3 months, after 6 months, after 12 months and at most after 24 months. This number of steps needs to know how to move into long-term memory. However, the duration of each time span depends on the individual and this is exactly what our system offers, an exact analysis when the right time has come.

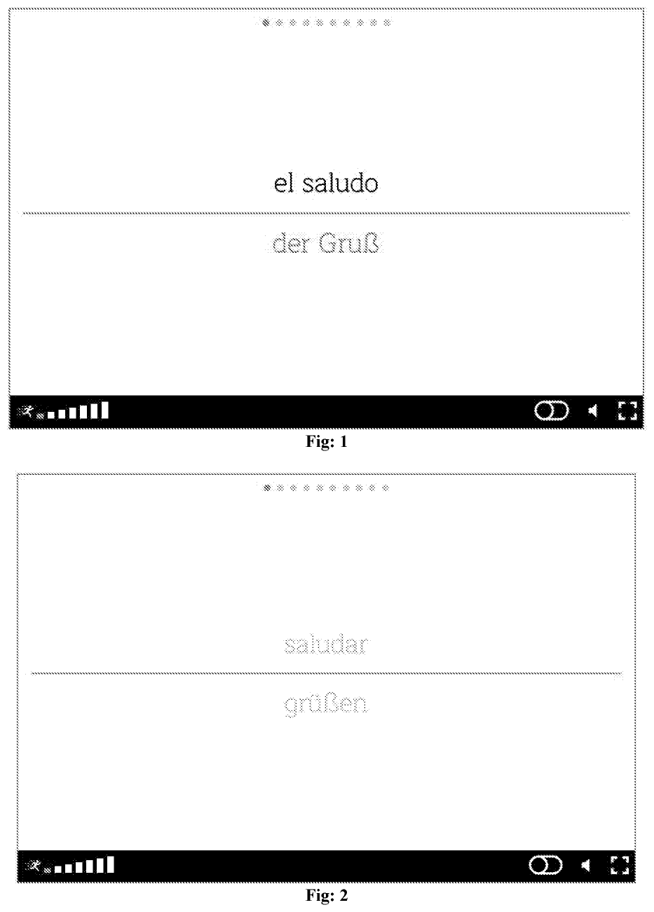

In-addition there are 10 dots, that one can see on the top FIG. 1 and FIG. 2 which signals where a person is, how much have he progressed or learned an added benefit is that it keeps the person motivated towards learning and proceeding.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

The invention is an e-learning platform comprising:

1) 10 vocabulary questions and answers with a maximum of 75 characters each are merged into one learning unit.

2) The query method with the insertion of the light gray and colored contents focuses the learner, switching between learning units supports learning in a subconscious way.

3) When multiple choice questions are asked, there is one question and one correct answer from the block of ten vocabulary, In this way, learning progress is also achieved in the query.
